(19) United States
(12) Patent Application Publication
(10) Pub. No.: US 2023/0064264 A1
(43) Pub. Date: Mar. 2, 2023

(54) METHOD FOR THE SURFACE TREATMENT OF ALUMINIUM-BASED PARTS

(71) Applicant: SAFRAN AEROSYSTEMS, Plaisir (FR)

(72) Inventors: Jean-Arthur DREVET, MOISSY-CRAMAYEL (FR); Valentin DESPREZ, MOISSY-CRAMAYEL (FR)

(73) Assignee: SAFRAN AEROSYSTEMS, Plaisir (FR)

(21) Appl. No.: 17/759,465

(22) PCT Filed: Jan. 21, 2021
(86) PCT No.: PCT/FR2021/050110

§ 371 Date: Jul. 26, 2022

(30) Foreign Application Priority Data
Jan. 31, 2020 (FR) 2000979

(51) Int. Cl. C25D 11/24; C25D 11/08; B05D 7/14; B05D 7/00

(52) U.S. Cl. CPC C25D 11/246; C25D 11/08; B05D 7/14; B05D 7/51

(57) ABSTRACT

A method for the surface treatment of a part made of aluminum or aluminum alloy, comprising an anodization step and a step of sealing with a silicate salt. Additionally, a surface treatment method according to the invention for manufacturing an aluminium or aluminium alloy part intended, in particular for use in the aviation sector.

### TECHNICAL FIELD OF THE INVENTION

The present invention is part of the search for new solutions to improve the bio-corrosion resistance properties of aluminium or aluminium alloy parts.

### BACKGROUND

The bio-corrosion encompasses all corrosion phenomena in which the micro-organisms and in particular the bacteria act directly or indirectly by means of their metabolism. It is an electrochemical phenomenon of dissolution of a metal that affects all the industries where micro-organisms and in particular the bacteria can develop. Most metals and alloys are sensitive to bio-corrosion: iron, steels, non- or low-alloyed, stainless steels, copper, aluminium and their alloys. The bio-corrosion is considered a serious problem in many industries such as aerospace and automobile, in oil fields and in marine environments. The economic loss directly associated with the bio-corrosion can reach billions of dollars each year. The prevention of the bio-corrosion of the metal or metal alloy parts has therefore attracted a considerable interest in recent decades.

One of the most common techniques to improve the bio-corrosion resistance properties of metal or metal alloy parts, in particular aluminium or aluminium alloy parts, is the anodization. The anodization is an electrolytic method that substitutes the natural oxide (native oxide), a few nanometres thick, which covers the aluminium, with a layer of oxide that can go up to several micrometres. The oxide layers produced by anodizing can have a thickness of around 10 μm, in order to provide long-term corrosion protection. Depending on the requirements, the anodic layer thickness can also vary from a few microns to 20-30 microns. The anodization, also referred to as anodic oxidation, consists of forming a porous aluminium oxide/hydroxide layer on the surface of the part, referred to as anodic layer, by applying a current to the part immersed in an electrolytic bath containing a strong acid type electrolyte, the part constituting the anode of the electrolytic system. The layer thus formed on the surface of the part, after a clogging treatment, allows to reinforce the corrosion resistance of the part. This clogged anodic layer can also be used as a support for the adhesion of paint systems.

In general, the anodic layers developed by anodization improve the corrosion resistance of the part but their high porosity makes them very sensitive to the aggressive environments. The porous structure does not provide an effective barrier against aggressive species such as microorganisms and it is the barrier layer that primarily ensures the protection. Thus, a suitable clogging treatment allows to increase the bio-corrosion resistance of the anodic layers.

The current anodization surface treatments, namely, OAC (Chromic Anodic Oxidation), TSA (Tartaric sulfuric Anodizing) as described for example in https://www.a3ts.org/actualite/commissions-techniques/fiches-techniques-traitement-surface/anodisation-sulfo-tartrique-oast-tartric-sulfuric-anodizing-tsa/, fine OAS (Fine Anodic Sulfuric Oxidation), OAS (Anodic Sulfuric Oxidation) as described for example in https://www.a3ts.org/news/technical-commissions/technical-sheets-surface-treatment/sulfuric-anodizing-version-5-2/, BSAA (Boric sulfuric Acid Anodizing) as described e.g. in https://www.anoplate.com/finishes/boric-sulfuric-acid-anodize-bsaa/, PSAA (Phosphoric sulfuric Acid Anodizing) as described e.g. in http://www.metroplating.co.uk/phosphoric-acid-anodising.php, etc., clogged with the standard products on the market do not resist the medium defined above. To date, none of these surface treatments are resistant to the bio-corrosion that can occur in the low points of aircraft reservoirs, for example. The corrosive acidic environment, linked to the release of acidic substances by microorganisms in the presence of a saline environment, attacks the anodized aluminium. This is directly related to the non-stability of anodization at pH<4.

In addition, the chromic anodic oxidation (OAC) and sulfuric anodic oxidation (OAS) methods, used to protect the aluminium alloys against corrosion, are impacted by the regulation REACH.

Another solution against the bio-corrosion is to paint the outer surfaces of the equipment in contact with these critical areas of the reservoirs. This generates additional costs and cycle times.

There is therefore a real need for a surface treatment method to improve the bio-corrosion resistance properties of aluminium or aluminium alloy parts that complies with the regulations REACH.

### SUMMARY OF THE INVENTION

The present invention aims to remedy the disadvantages of the anodization methods of aluminium or aluminium alloy parts, exposed above, in particular, in terms of resistance to bio-corrosion of the treated part.

The present invention is precisely intended to meet these needs, in particular, in terms of bio-corrosion resistance of the treated part, by providing a method for surface treating an aluminium or aluminium alloy part, comprising at least the following steps:

A) an anodization step; and
B) a step of clogging the anodic layer formed on said part after the step A) the clogging being realized in an aqueous solution of deionized water having a resistivity equal to or greater than 0.01 MOhms, preferably equal to or greater than 0.1 MOhms, more preferably equal to or greater than 10 MOhms, and from 1 to 500 g/L of an alkali metal or alkaline-earth metal silicate, at a temperature of between 60° C. and 100° C.

In one embodiment of the invention, the anodization step A) is an anodization during which said part is immersed in an aqueous bath comprising sulfuric acid at a concentration of between 150 and 250 g/L and at a temperature of between 14 and 21° C., and a direct voltage is applied to said immersed part according to a voltage profile comprising a voltage rise at a rate of less than 1 V/min until a voltage value referred to as plateau of between 5 and 13 V is reached.

Another embodiment of the invention consists in performing, after the clogging step B), a post-clogging rinsing (step B1)) in a deionized water having a resistivity equal to or greater than 0.01 MOhms, preferably equal to or greater than 0.1 MOhms, more preferably equal to or greater than 10 MOhms, at a temperature of between 15 and 35° C.

Another embodiment of the invention consists in realizing, prior to the silicate salt clogging step (step B)), an immersion step A1) of said part,
in an aqueous bath containing a trivalent chromium salt selected from the group consisting of CrF₃,xH₂O, CrCl₃,xH₂O, Cr(NO₃)₃,xH₂O, (CH₃CO₂)₂Cr,xH₂O, (CH₃CO₂)₇Cr₃(OH)₂,xH₂O, Cr₂(SO₄)₃,xH₂O, CrK(SO₄)₂,xH₂O (step A1-1));

then optionally
in an aqueous bath containing an oxidizing compound selected from the group consisting of hydrogen peroxide (H₂O₂), ammonium fluoride (NH₄F), potassium fluoro-zirconate (K₂ZrF₆), potassium permanganate (KMnO₄), sodium permanganate (NaMnO₄) (step A1-2).

In another embodiment, after the silicate salt clogging according to the step B), the surface treatment method may further comprise a final hydrothermal clogging (step C)) in a deionized water with a resistivity equal to or greater than 0.01 MOhms, preferably equal to or greater than 0.1 MOhms, more preferably equal to or greater than 10 MOhms, at a temperature between 97 and 100° C.

The surface treatment method of the invention significantly improves the bio-corrosion resistance properties of aluminium or aluminium alloy parts and meets the requirements of the regulation REACH.

The method of the invention is of great interest in any type of industry where one seeks to improve the bio-corrosion resistance properties of aluminium or aluminium alloy parts, such as in the aeronautics, automobile, oil industry, etc.

Another object of the invention concerns a method for manufacturing an aluminium or aluminium alloy part for use in the aeronautical sector comprising

(i)—a step of surface treating said part by a method according to the invention, and optionally

(ii)—a step of applying one or more layers of paint, varnish, dry lubricants, or mastics.

Another object of the invention is the use of a surface treatment method according to the invention, for the manufacture of aluminium or aluminium alloy parts intended for the aeronautical sector.

The invention also has as its object an anodized aluminium or aluminium alloy part clogged by a surface treatment method according to the invention, comprising one or more layers of paints, varnish, dry lubricants or mastics, said part being intended for the aeronautical sector.

### BRIEF DESCRIPTION OF THE FIGURES

Further characteristics and advantages of the invention will become apparent from the following detailed description, for the understanding of which reference is made to the attached drawings in which:

FIG. 1 shows the mounting diagram for realizing the bio-corrosion test on parts treated by the method of the invention and by the methods of the prior art, according to § 4.7.19 of the MIL-C-27725B standard.

### DETAILED DESCRIPTION OF THE INVENTION

The purpose of the present invention is to meet the needs of the prior art, in particular, in terms of bio-corrosion resistance of the treated part, by providing a method for surface treating an aluminium or aluminium alloy part, comprising at least the following steps:

A) an anodization step; and
B) a step of clogging the anodic layer formed on said part after the step A) the clogging being realized in an aqueous solution of deionized water having a resistivity equal to or greater than 0.01 MOhms, preferably equal to or greater than 0.1 MOhms, more preferably equal to or greater than 10 MOhms, and from 1 to 500 g/L of an alkali metal or alkaline-earth metal silicate, at a temperature of between 60° C. and 100° C.

According to a preferred embodiment of the invention, the anodization step A) is an anodization during which said part is immersed in an aqueous bath comprising sulfuric acid at a concentration of between 150 and 250 g/L and at a temperature of between 14 and 21° C., and

a direct voltage is applied to said immersed part according to a voltage profile comprising a voltage rise at a rate of less than 1 V/min until a voltage value referred to as plateau of between 5 and 13 V is reached.

Once the voltage value referred to as plateau is reached, the applied voltage is maintained at said plateau value for an adequate period of time in order to obtain an anodic layer on the surface of said part with a thickness of between 2 and 7 μm.

The voltage applied to said immersed part can be maintained at the plateau value for a period of time between 20 and 80 minutes.

The voltage value referred to as plateau can be between 6 and 10V.

This anodization is a fine OAS.

In the method of the invention, the anodization step A) can also be an anodization of the TSA (sulfo-tartaric anodic oxidation), OAS (sulfuric anodic oxidation), PSAA (sulfuric phosphoric acid anodic oxidation), BSAA (sulfuric boric acid anodic oxidation), or OAC (chromic anodic oxidation) type.

The method of the invention is particularly suitable for aluminium and aluminium alloy parts selected from the group consisting of 2014, 2017A, 2024, 2214, 2219, 2618, AU5NKZr, 7175, 5052, 5086, 6061, 6063, 7010, 7020, 7050, 7050 T7451, 7055 T77, 7068, 7085 T7651, 7075, 7175 et 7475, AS7G06, AS7G03, AS10G, AS9U3, AS7G06 and AS10G obtained by a different mode of production, namely, by additive manufacturing.

As indicated, the voltage profile applied to the part comprises a voltage rise, from a starting value of 0V, at a rate lower than 1V/min, preferably 0.3V/min to 0.7V/min, until reaching a voltage value referred to as plateau of between 5 and 13V, preferably between 6 and 10V. The voltage applied to said part immersed in said bath is then maintained at said plateau value for a suitable period of time in order to obtain on the surface of said part an anodic layer of aluminium oxides/hydroxides with a thickness of between 2 and 7 μm, for example, with a thickness equal to approximately 3 μm.

According to an embodiment of the invention, the voltage applied to said immersed part is maintained at the plateau value for a period of time between 20 and 80 minutes, preferably between 30 and 60 minutes.

Without wishing to be bound by any theory, the inventors have unexpectedly found that during the anodization by the preferred fine OAS anodization method described above, the slower the voltage rise, the greater the bio-corrosion resistance of the anodic layer formed on the surface of the part. In the same way, the lower the applied voltage, the higher the bio-corrosion resistance of said anodic layer. These two parameters allow to create a less porous, denser and therefore more bio-corrosion resistant layer.

In the anodization step A) according to the preferred embodiment of the invention, the sulfuric acid concentration in the bath is preferably between 160 g/L and 220 g/L, for example equal to 190 g/L.

In the anodization step A) according to the preferred embodiment of the invention, the bath temperature can be between 10 and 25° C., preferably between 14 and 21° C., for example 18° C.

In the method of the invention, the anodization step A) is directly or indirectly followed by a step B) which is a step of clogging the anodic layer formed on said part during the step A). As mentioned above, the clogging of the step B) is realized in an aqueous solution
of deionized water having a resistivity equal to or greater than 0.01 MOhms, preferably equal to or greater than 0.1 MOhms, and more preferably equal to or greater than 10 MOhms), and
1 to 500 g/L of an alkali metal or alkaline-earth metal silicate.

The alkali metal or alkaline-earth metal silicate can be selected from the group consisting of lithium silicate, sodium silicate, potassium silicate, calcium silicate and magnesium silicate.

The water quality of the clogging bath is important because it has an impact on the resistance of the anodic layer formed on the part to bio-corrosion. A purer water such as, for example, a water with a resistivity equal to or higher than 10 MOhms is likely to provide better performance over time than a water with a resistivity lower than 10 MOhms. According to a preferred embodiment, the deionized water is a mounting water, i.e. a water used to fill an active bath during mounting/filling thereof, said water having a resistivity equal to or greater than 0.01 MOhms, preferably equal to or greater than 0.1 MOhms, more preferably equal to or greater than 10 MOhms.

In the clogging step B), the concentration of alkali metal or alkaline-earth metal silicate in the solution is preferably between 15 and 40 g/L, for example 23 g/L.

The temperature of the clogging solution in the step B) can be between 60° C. and 100° C., preferably between 97° C. and 100° C., for example 98° C.

The duration of the clogging step B) is between 1 and 40 minutes, preferably between 15 and 25 minutes, for example 20 minutes.

In accordance with one embodiment of the invention, prior to the silicate salt clogging step (step B)), an immersion step A1) of said part,
in an aqueous bath containing a trivalent chromium salt selected from the group consisting of CrF₃,xH₂O, CrCl₃,xH₂O, Cr(NO₃)₃,xH₂O, (CH₃CO₂)₂Cr,xH₂O, (CH₃CO₂)₂Cr₃(OH)₂,xH₂O, Cr₂(SO₄)₃,xH₂O, CrK(SO₄)₂,xH₂O (step A1-1));

then optionally
in an aqueous bath containing an oxidizing compound selected from the group consisting of hydrogen peroxide (H₂O₂), ammonium fluoride (NH₄F), potassium fluoro-zirconate (K₂ZrF₆), potassium permanganate (KMnO₄), sodium permanganate (NaMnO₄) (step A1-2));

can take place.

The trivalent chromium salt can be, for example, one of the following commercial products: Surtec 650 from the company SURTEC, Lanthane 613.3 from the company COVENTYA, TCS from the company SOCOMORE, Bonderite MNT 65000 from the company HENKEL.

The oxidizing compound can be, for example, the product PACS of the company SOCOMORE.

In the immersion step A1), the steps A1-1) and A1-2) can take place successively in the following order: step A1-1) then step A1-2). The immersion step A1), can also be the step A1-1) alone without being followed by the step A1-2).

The temperature of the aqueous bath containing the trivalent chromium salt and that of the aqueous bath containing the oxidizing compound in the step A1-1) and A1-2) as described above are between 20 and 80° C., preferably between 20 and 60° C. The temperatures of the two baths can be the same or different.

The immersion time in each bath in the step A1) can be the same or different. It can be between 5 and 40 minutes, preferably between 5 and 20 minutes.

The pH of the bath containing a trivalent chromium salt can be between 3 and 4.5, preferably between 3 and 4, for example 3.5.

The concentration of trivalent chromium salt in the bath is preferably between 0.5 and 500 g/L.

The pH of the bath containing an oxidizing compound is between 3 and 6.

The concentration of oxidizing compound in the bath is preferably between 0.1 and 500 g/L.

According to another embodiment of the invention, the method further comprises a final hydrothermal clogging after the silicate salt clogging according to the step B), which will be referred to as step C). The final hydrothermal clogging C) is realized in a deionized water with a resistivity equal to or greater than 0.01 MOhms, preferably equal to or greater than 0.1 MOhms, and more preferably equal to or greater than 10 MOhms, and at a temperature T>96° C., for example, between 97 and 100° C.

In the final hydrothermal clogging C), the part is immersed in a deionized water with a resistivity of, advantageously, 10 MOhms or more. The immersion of the part in this step can be from 10 to 30 minutes, preferably from 15 to 25 minutes.

According to an embodiment of the invention, the method of surface treating an aluminium or aluminium alloy part, according to the invention, comprises the following steps:

A) an anodization step during which said part is immersed in an aqueous bath comprising sulfuric acid at a concentration of between 150 and 250 g/L and at a temperature of between 14 and 21° C., and

a direct voltage is applied to said immersed part according to a voltage profile comprising a voltage rise at a rate of less than 1 V/min until reaching a voltage value referred to as plateau of between 5 and 13 V; and

B) a step of clogging the anodic layer formed on said part after the step A)

the clogging being realized in an aqueous solution of deionized water having a resistivity equal to or greater than 0.01 MOhms, preferably equal to or greater than 0.1 MOhms, more preferably equal to or greater than 10 MOhms, and from 1 to 500 g/L of an alkali metal or alkaline-earth metal silicate, at a temperature of between 60° C. and 100° C.

According to another embodiment of the invention, the method for surface treating an aluminium or aluminium alloy part, according to the invention, comprises the following steps:

A) an anodization step during which said part is immersed in an aqueous bath comprising sulfuric acid at a concentration of between 150 and 250 g/L and at a temperature of between 14 and 21° C., and

a direct voltage is applied to said immersed part according to a voltage profile comprising a voltage rise at a rate of less than 1 V/min until a voltage value referred to as plateau of between 5 and 13 V is reached;

A1) an immersion step of said part,
in an aqueous bath containing a trivalent chromium salt selected from the group consisting of CrF₃,xH₂O, CrCl₃,xH₂O, Cr(NO₃)₃,xH₂O, (CH₃CO₂)₂Cr,xH₂O, (CH₃CO₂)₂Cr₃(OH)₂,xH₂O, Cr₂(SO₄)₃,xH₂O, CrK(SO₄)₂,xH₂O (step A1-1));

then
in an aqueous bath containing an oxidizing compound selected from the group consisting of hydrogen peroxide (H₂O₂), ammonium fluoride (NH₄F), potassium fluoro-zirconate (K₂ZrF₆), potassium permanganate (KMnO₄), sodium permanganate (NaMnO₄) (step A1-2); and

B) a clogging step realized in an aqueous solution of deionized water having a resistivity equal to or greater than 0.01 MOhms, preferably equal to or greater than 0.1 MOhms, more preferably equal to or greater than 10 MOhms, and from 1 to 500 g/L of an alkali metal or alkaline-earth metal silicate, at a temperature of between 60° C. and 100° C.

According to another embodiment of the invention, the method for surface treating an aluminium or aluminium alloy part, according to the invention, comprises the following steps:

A) an anodization step during which said part is immersed in an aqueous bath comprising sulfuric acid at a concentration of between 150 and 250 g/L and at a temperature of between 14 and 21° C., and

a direct voltage is applied to said immersed part according to a voltage profile comprising a voltage rise at a rate of less than 1 V/min until a voltage value referred to as plateau of between 5 and 13 V is reached;

A1) an immersion step of said part,
in an aqueous bath containing a trivalent chromium salt selected from the group consisting of CrF₃,xH₂O, CrCl₃,xH₂O, Cr(NO₃)₃,xH₂O, (CH₃CO₂)₂Cr,xH₂O, (CH₃CO₂)₇Cr₃(OH)₂,xH₂O, Cr₂(SO₄)₃,xH₂O, CrK(SO₄)₂,xH₂O (step A1-1));

then
in an aqueous bath containing an oxidizing compound selected from the group consisting of hydrogen peroxide (H₂O₂), ammonium fluoride (NH₄F), potassium fluoro-zirconate (K₂ZrF₆), potassium permanganate (KMnO₄), sodium permanganate (NaMnO₄) (step A1-2));

B) a clogging step realized in an aqueous solution of deionized water having a resistivity equal to or greater than 0.01 MOhms, preferably equal to or greater than 0.1 MOhms, more preferably equal to or greater than 10 MOhms, and from 1 to 500 g/L of an alkali metal or alkaline-earth metal silicate, at a temperature between 60° C. and 100° C.; and

C) a final hydrothermal clogging in a deionized water with a resistivity equal to or greater than 0.01 MOhms, preferably equal to or greater than 0.1 MOhms, and more preferably equal to or greater than 10 MOhms, at a temperature between 97 and 100° C.

According to yet another embodiment of the invention, the method for surface treating an aluminium or aluminium alloy part, according to the invention, comprises the following steps:

A) an anodization step during which said part is immersed in an aqueous bath comprising sulfuric acid at a concentration of between 150 and 250 g/L and at a temperature of between 14 and 21° C., and

a direct voltage is applied to said immersed part according to a voltage profile comprising a voltage rise at a rate of less than 1 V/min until a voltage value referred to as plateau of between 5 and 13 V is reached;

A1) an immersion step of said part,
in an aqueous bath containing a trivalent chromium salt selected from the group consisting of CrF₃,xH₂O, CrCl₃,xH₂O, Cr(NO₃)₃,xH₂O, (CH₃CO₂)₂Cr,xH₂O, (CH₃CO₂)₇Cr₃(OH)₂,xH₂O, Cr₂(SO₄)₃,xH₂O, CrK(SO₄)₂,xH₂O (step A1-1)); and

B) a clogging step realized in an aqueous solution of deionized water having a resistivity equal to or greater than 0.01 MOhms, preferably equal to or greater than 0.1 MOhms, more preferably equal to or greater than 10 MOhms, and from 1 to 500 g/L of an alkali metal or alkaline-earth metal silicate, at a temperature of between 60° C. and 100° C.

In another embodiment of the invention, the method for surface treating an aluminium or aluminium alloy part, according to the invention, comprises the following steps:

A) an anodization step during which said part is immersed in an aqueous bath comprising sulfuric acid at a concentration of between 150 and 250 g/L and at a temperature of between 14 and 21° C., and

a direct voltage is applied to said immersed part according to a voltage profile comprising a voltage rise at a rate of less than 1 V/min until a voltage value referred to as plateau of between 5 and 13 V is reached;

Im) a step of impregnating said anodized part at the end of the step A) in a bath of organic or inorganic dyes, then optionally

A1) an immersion step of said part,
in an aqueous bath containing a trivalent chromium salt selected from the group consisting of CrF₃,xH₂O, CrCl₃,xH₂O, Cr(NO₃)₃,xH₂O, (CH₃CO₂)₂Cr,xH₂O, (CH₃CO₂)₇Cr₃(OH)₂,xH₂O, Cr₂(SO₄)₃,xH₂O, CrK(SO₄)₂,xH₂O (step A1-1));
then
in an aqueous bath containing an oxidizing compound selected from the group consisting of hydrogen peroxide (H₂O₂), ammonium fluoride (NH₄F), potassium fluoro-zirconate (K₂ZrF₆), potassium permanganate (KMnO₄), sodium permanganate (NaMnO₄) (step A1-2)); and then optionally

B) a clogging step realized in an aqueous solution of deionized water having a resistivity equal to or greater than 0.01 MOhms, preferably equal to or greater than 0.1 MOhms, more preferably equal to or greater than 10 MOhms, and from 1 to 500 g/L of an alkali metal or alkaline-earth metal silicate, at a temperature of between 60° C. and 100° C.

The step Im) can be realized by any technique known to the person skilled in the art. For example, it can be realized in a dye bath adapted to the surface treatment available from companies like Clariant. As an example, we can mention the organic dye Sanodal Blue (from the company Clariant) with a concentration of 3 g/L to which 2 g/L of sodium acetate must be added, pH between 5 and 6 at a temperature between 40 and 65° C., preferably equal to 50° C., for a duration of between 5 and 35 minutes, preferably equal to 20 minutes. The active principle of the organic dye is the Anthraquinone molecule.

In all embodiments, before subjecting the part to the surface treatment method of the invention and therefore prior to the anodization step A), the part may be subjected to a surface preparation step by degreasing and/or pickling in order to remove the grease, dirt and oxides present on its surface.

This preliminary step of surface preparation can comprise one or more of the following operations:
solvent degreasing, to dissolve grease on the surface of the part. This operation can be realized by soaking, spraying, or any other method known to the person skilled in the art;
alkaline degreasing, to dissolve grease on the surface of the part. This operation can be realized by soaking, spraying, or any other technique known to the person skilled in the art;
alkaline pickling, to dissolve the oxides naturally formed on the surface of the part. This operation can be realized by soaking, spraying, or any other technique known to the person skilled in the art. At the end of this operation, the part is covered with a powdery layer formed by oxidation products of intermetallic compounds, which must be removed by an acid pickling step;
acid pickling, to dissolve the oxides naturally formed on the surface of the part, and/or the oxidation layer formed on the surface of the part during the alkaline pickling step. This operation can be realized by soaking, spraying, or any other technique known to the person skilled in the art.

These steps are described in detail, for example, in the application WO 2013/117759.

Intermediate rinses, in particular with demineralized water, are preferably realized between the above successive steps and before the part is treated by anodization.

The surface treatment method of the invention significantly improves the bio-corrosion resistance properties of aluminium or aluminium alloy parts and meets the requirements of the regulation REACH.

The method of the invention is of great interest in any type of industry where one seeks to improve the bio-corrosion resistance properties of aluminium or aluminium alloy parts, such as in the aeronautics, automobile, oil industry, etc.

Another object of the invention concerns a method for manufacturing an aluminium or aluminium alloy part for use in the aeronautical sector comprising

(i)—a step of surface treating said part by a method according to the invention, and optionally

(ii)—a step of applying one or more layers of paint, varnish, dry lubricants, or mastics.

The application of one or more layers of paint, varnish, dry lubricants or mastics can be done by any method known to the person skilled in the art. Furthermore, the person skilled in the art will know how to choose the suitable paints, varnish, dry lubricants and mastics for use in the aeronautical sector.

Another object of the invention is the use of a surface treatment method according to the invention, for the manufacture of aluminium or aluminium alloy parts intended for the aeronautical sector.

The invention also has as its object an anodized aluminium or aluminium alloy part clogged by a surface treatment method according to the invention, comprising one or more layers of paints, varnish, dry lubricants or mastics, said part being intended for the aeronautical sector.

### EXAMPLES

### Example 1

Method for Treating the Surface of an Aluminium Alloy Part

Rolled 2024 T3 aluminium alloy parts machined on one of the two faces with dimensions 120×60×2 mm are treated according to the methods described below.

The surface preparation steps of the part are first realized successively:
Alkaline degreasing, by soaking the part in a bath of ALUMAL CLEAN 101 (from the company COVENTYA) at a temperature of 60° C., for 20 minutes;
rinsing with tap water or demineralized water;
acid pickling: by soaking the part in a solution of ALUMAL DEOX 411 (from the company COVENTYA);
rinsing with tap water or demineralized water.

The pickled and rinsed parts are then subjected to an anodization method in accordance with the invention, during which the parts are immersed in an aqueous bath comprising sulfuric acid at a concentration of between 160 g/L and 220 g/L, for example equal to 190 g/L. This bath is carried and maintained at a temperature of 18° C. A direct voltage is applied to the immersed parts according to the following voltage profile: voltage rise from a value of 0V, at a speed of 0.4 V/min until reaching a voltage value referred to as plateau of 6V. The voltage is maintained at the plateau value for 50 minutes. An anodic layer with a thickness of 2 to 4 μm is formed on the surface of the parts.

As a comparative example, identical parts that have undergone the same surface preparation operations are anodized using the conventional methods of chromic anodizing (OAC) and fine sulfuric anodizing (fine OAS). The operating conditions for these anodization are shown in [Table 1].

TABLE 1

| | OAC | fine OAS |
|---|---|---|
| Composition of the bath | CrO₃ (60 g/L) | H₂SO₄ |
| | C₂H₂O₄ (2 g/L) | |
| Temperature of the bath | 35-42 | 16-20 |
| (° C.) | | |
| Voltage rise (V/min) | 7 | 0.4 |
| Voltage and plateau time | 35 V | 6V |
| | 45 minutes | 50 minutes |
| Thickness of the anodic | 3 to 5 | 2 to 4 |
| layer formed on the part | | |
| (pm) | | |

The thickness of the anodic layer formed on the part is measured by eddy current according to the standard ISO2360.

The anodized parts according to the invention are then subjected to one or more rinses, preferably with demineralized water, followed by the clogging operations according to the invention under the conditions and in the order indicated below:
step A1.1) and step A1.2): a step of immersing said parts, successively, in an aqueous bath containing 29% Vol/Vol of trivalent Chromium salt (Chromium III potassium sulphate of chemical formula KCr(SO₄)₂), at a temperature of 40° C. for 20 minutes and at a pH of 3.9, then

in an aqueous bath containing 7% Vol/Vol H₂O₂, at a temperature of 25° C. for 5 minutes and a pH of 4.2;
step B): a clogging by immersion of the parts at the end of the two preceding operations in an aqueous solution of deionized mounting water having a resistivity of 10 MOhms with 23 g/L of a sodium silicate, a temperature of 98° C. and during 20 minutes.

Between each clogging step a rinse with demineralized water is performed for 1 minute at a temperature of about 20° C.

By way of comparison, the parts anodized using the conventional OAC and fine OAS methods are also subjected to one or more conventional clogging operations such as hot clogging with hexavalent chromium salts (for OAC), hydrothermal hot clogging with prior pre-clogging (or impregnation) with trivalent chromium salts and in an oxidizing bath, according to the conditions indicated in [Table 2].

TABLE 2

| | Clogging | Clogging with |
|---|---|---|
| | hydrothermal | chromium VI salts |
| Composition | H₂O | K₂CrO₇ |
| | | 30 mg/L |
| Temperature ° C. | 98 | 98 |
| Immersiontime | 30 | 30 |
| (minutes) | | |
| PH | 5-7 | 5.5-6.5 |

Resistance to the Bio-Corrosion

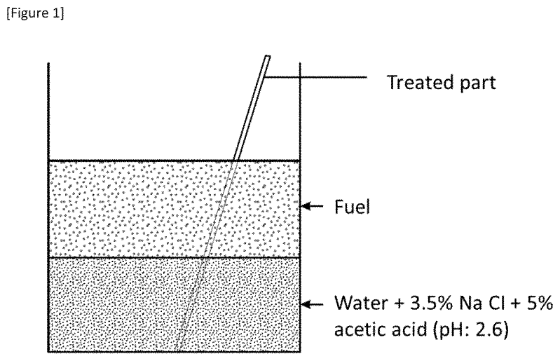

At the end of these clogging operations, a clogged anodic layer is obtained on each treated part. Once treated, the parts are subjected to the immersion test in a medium representative of the bio-corrosion which follows the protocol in § 4.7.19 of the standard MIL-27725B. The diagram of the mounting to realize the bio-corrosion test according to the § 4.7.19 of the MIL-C-27725B standard with the different parts is shown in [FIG. 1].

The evaluation of the results is done visually by removing the parts from the medium in order to note possible marks of degradation of the treatment and/or attacks of the substrate by the medium (lower phase). This test was conducted in comparison to historical treatments (OAC) and more recent prior art alternative treatments (REACH compliant). The visual degradation can be confirmed by a measurement of Ohmic resistivity of layer which, when it is not infinite, highlights a deterioration of the layer which can go until the substrate.

Method for Measuring a Resistance with an Ohmmeter:

A multimeter can be used to measure resistance. It must then be used in Ohmmeter mode.

Using the Multimeter in Ohmmeter Mode:

Choice of terminals: the COM terminal and the terminal carrying the Ω symbol.

Connection: the multimeter is connected directly at two points of the test specimen under test on the area that has been in contact with the lower phase of the two-phase medium.

The size: the highest size is chosen and then it is decreased until the smallest of the sizes above the measured value is found.

[Table 3] summarizes the results of bio-corrosion resistance tests of different surface treatments as a function of the number of days of immersion in the biphasic medium.

TABLE 3

| Treatment of | Immersion time in the biphasic fluid | | | | | |
|---|---|---|---|---|---|---|
| the parts | 0 days | 7 days | 9 days | 13 days | 15 days | 30 days |
| OAC + CrVI | Launch of | Numerous | Generalized | Generalized | Stop | — |
| clogging | the tests | corrosion | corrosion + | corrosion + | testing + | |
| | | pits + | non- | non- | Ohmic | |
| | | Ohmic | infinite | infinite | resistivity | |
| | | resistivity | ohmic | ohmic | not | |
| | | not infinite | resistivity | resistivity | infinite | |
| Fine OAS + | | Corrosion | general | Generalized | Stop | — |
| Crill clogging + | | generalized + | corrosion + | corrosion + | testing + | |
| Oxidizing bath + | | Ohmic | Ohmic | Ohmic | Ohmic | |
| hydrothermal | | resistivity | resistivity | resistivity | resistivity | |
| clogging | | not infinite | not | not | not | |
| | | | infinite | infinite | infinite | |
| Method of the | | No | No | No | No | A pitting |
| invention | | corrosion + | corrosion + | corrosion + | corrosion + | on the |
| | | infinite | infinite | infinite | infinite | lower |
| | | Ohmic | Ohmic | Ohmic | Ohmic | edge + |
| | | resistivity | resistivity | resistivity | resistivity | infinite |
| | | | | | | Ohmic |
| | | | | | | resistivity |

The pits corrosion is a localized corrosion that results in the formation of irregularly shaped cavities on the surface of the aluminium alloy part. They occur when the aluminium alloy part is brought into contact with an aqueous solution containing halide ions, most frequently chloride ions. Based on the results shown in [Table 3], it is clear that the surface treatment according to the invention allows at least a doubling of the bio-corrosion test performances compared to conventional surface treatments.

The behaviour observed on the part that has had the treatment according to the invention is equivalent to the behaviour obtained on painted parts (by anaphoresis for example) that would undergo the same tests.

### Example 2

Voltage Rise Rate in the Fine OAS Anodization Step

12 specimens were degreased and pickled under the same conditions as for example 1. They were then anodized with different voltage rise times (5 minutes and 15 minutes) and different plateau voltages (6, 10 and 13 Volts respectively for durations of 50, 40 and 30 minutes). Then these specimens were successively immersed in the baths of steps A1-1), A1-2) under the same conditions as those described in example 1. The specimens 1, 3, 6, 7, 9 and 11 were then immersed for 30 minutes in a final hydrothermal clogging bath in deionized water with a resistivity equal to or greater than 10 MOhms, at a temperature of 98° C. (step C)) previously).

The specimens 2, 4, 5, 8, 10, 12 were clogged and then rinsed following the same conditions as described in example 1 (step B)) with associated post-rinse).

The thicknesses of the clogged anodic layers were measured by eddy current according to the ISO2360 standard. The conditions and the thickness measurements of the layers are shown in [Table 4].

TABLE 4

| | | Thickness | | |
|---|---|---|---|---|
| | | (in μm) | Speed of | Plateau |
| | | measuredby | voltage rise | voltage |
| | | eddy current | during fine | during |
| Specimen | | according to | OAS | fine OAS |
| number | Type of clogging | ISO2360 | anodization | anodization |
| 1 | Hydrothermal | 2.7 | 15 min | 6 V |
| | (without silicate | | | |
| | salt) | | | |
| 2 | Cloggingwith | 2.5 | 15 min | 6 V |
| | silicatesalt | | | |
| | (according to the | | | |
| | invention) | | | |
| 3 | Hydrothermal | 4.0 | 5 min | 6 V |
| | (without silicate | | | |
| | salt) | | | |
| 4 | Cloggingwith | 3.8 | 5 min | 6 V |
| | silicatesalt | | | |
| | (according to the | | | |
| | invention) | | | |
| 5 | Cloggingwith | 5.5 | 15 min | 10 V |
| | silicatesalt | | | |
| | (according to the | | | |
| | invention) | | | |
| 6 | Hydrothermal | 6.9 | 15 min | 10 V |
| | (without silicate | | | |
| | salt) | | | |
| 7 | Hydrothermal | 5.7 | 5 min | 10 V |
| | (without silicate | | | |
| | salt) | | | |

The bio-corrosion resistance of the specimens was then tested under the same conditions and control types as in Example 1. The checks were performed after 14 and 17 days of immersion. The results are shown in [Table 5].

After 17 days of immersion, the test results show that when the clogging is realized in a bath with the silicate salt according to the invention, the appearance of the specimen remains unchanged or very slightly discoloured. On the contrary, a generalized corrosion is noted when the clogging is hydrothermal for the specimens anodized at 13 and 10 Volts. The effect is much less pronounced for the specimens 1 and 3 anodized at 6 volts. It is also noted that for the 6 and 10 volt anodized specimens clogged with silicate salt, a 15 minute voltage rise provides better results than a 5 minute voltage rise.

Consequently, it can be deduced from these results that a slower voltage rise (15 minutes preferred over 5 minutes) with a plateau voltage preferably equal to 10 or 6 Volts, with silicate salt clogging according to the invention provides the best results for withstanding the bio-corrosion simulation test

TABLE 5

| | | | Evaluation of the ohmic | |
|---|---|---|---|---|
| | Visual | | resistance of the | |
| | evaluation of aspect change | | surface with an ohmmeter | |
| | 14 days of | | | |
| | immersion | 17 days of | 14 days of | 17 days of |
| | in the | immersion in | immersion in | immersion in |
| Specimen | biphasic | the biphasic | the biphasic | the biphasic |
| number | environment | environment | environment | environment |
| 1 | Uniform | Uniform | Non-infinite | Non-infinite |
| | discoloration | discoloration | ohmic | ohmic |
| | | | resistance | resistance |
| 2 | No change in | No change in | Infinite ohmic | Infinite ohmic |
| | appearance | appearance | resistance | resistance |
| 3 | Uniform | Uniform | Non-infinite | Non-infinite |
| | discoloration | discoloration | ohmic | ohmic |
| | | | resistance | resistance |
| 4 | Uniform | Uniform | Infinite ohmic | Infinite ohmic |
| | discoloration | discoloration | resistance | resistance |
| 5 | No change in | No change in | Infinite ohmic | Infinite ohmic |
| | appearance | appearance | resistance | resistance |
| 6 | Generalized | Generalized | Non-infinite | Non-infinite |
| | corrosion | corrosion | ohmic | ohmic |
| | | | resistance | resistance |
| 7 | Generalized | Generalized | Non-infinite | Non-infinite |
| | corrosion | corrosion | ohmic | ohmic |
| | | | resistance | resistance |

1. A method for surface treating an aluminium or aluminium alloy part, comprising:
anodizing the part; and
clogging an anodic layer formed on the part after anodizing, by clogging the part in an aqueous solution of deionized water having a resistivity equal to or greater than 0.01 MOhms, and from 1 to 500 g/L of an alkali metal or alkaline-earth metal silicate, at a temperature of between 60° C. and 100° C.

2. The method according to claim 1, wherein anodizing comprises immersing the part in an aqueous bath comprising sulfuric acid at a concentration of between 150 and 250 g/L and at a temperature of between 14 and 21° C., and
applying a direct voltage to the immersed part according to a voltage profile comprising a voltage rise at a rate of less than 1 V/min until a voltage value plateau between 5 and 13 V is reached.

3. The method according to claim 1, wherein said anodizing the part comprises TSA (sulfo-tartaric anodic oxidation), OAS (sulfuric anodic oxidation), PSAA (sulfuric phosphoric acid anodic oxidation), BSAA (sulfuric boric acid anodic oxidation), or OAC (chromic anodic oxidation) type anodizing.

4. The method according to claim 1, wherein the aluminium alloy is selected from a group consisting of 2014, 2017A, 2024, 2214, 2219, 2618, AU5NKZr, 7175, 5052, 5086, 6061, 6063, 7010, 7020, 7050, 7050 T7451, 7055 T77, 7068, 7085 T7651, 7075, 7175, and 7475, AS7G06, AS7G03, AS10G, AS9U3, AS7G06, and AS10G obtained by additive manufacturing.

5. The method according to claim 1, wherein the alkali metal or alkaline-earth metal silicate is selected from a group consisting of lithium silicate, sodium silicate, potassium silicate, calcium silicate and magnesium silicate.

6. The method according to claim 2, wherein the voltage applied to the part immersed in the bath is then maintained at the voltage value plateau for an adequate period of time in order to obtain on a surface of said part an anodic layer with a thickness of between 2 and 7 μm.

7. The method according to claim 2, wherein the voltage applied to the immersed part is maintained at the voltage value plateau for a time period between 20 and 80 minutes.

8. The method according to claim 2, wherein the voltage value plateau is between 6 and 10V.

9. The method according to claim 1, further comprising rinsing the part in a deionized water having a resistivity equal to or greater than 0.01 MOhms, at a temperature of between 15 and 35° C.

10. The method of surface treating according to claim 1, wherein the method further comprises:
immersing the part in an aqueous bath containing a trivalent chromium salt selected from a group consisting of CrF₃,xH₂O, CrCl₃,xH₂O, Cr(NO₃)₃,xH₂O, (CH₃CO₂)₂Cr,xH₂O, (CH₃CO₂)₇Cr₃(OH)₂,xH₂O, Cr₂(SO₄)₃,xH₂O, CrK(SO₄)₂,xH₂O;
then optionally
immersing the part in an aqueous bath containing an oxidizing compound selected from a group consisting of hydrogen peroxide (H₂O₂), ammonium fluoride (NH₄F), potassium fluoro-zirconate (K₂ZrF₆), potassium permanganate (KMnO₄), sodium permanganate (NaMnO₄).

11. The method according to claim 10, wherein the temperature of the aqueous bath containing the trivalent chromium salt and that of the aqueous bath containing the oxidizing compound are between 20 and 80° C.

12. The method according to claim 1, further comprising hydrothermally clogging the part in a deionized water with a resistivity equal to or greater than 0.01 MOhms at a temperature of between 97 and 100° C., after clogging the part with silicate salt.

13. The method of surface treating according to claim 10, wherein the concentration of trivalent chromium salt in the aqueous bath is between 0.5 and 500 g/L, and that of the oxidizing compound in the aqueous bath is between 0.1 and 500 g/L.

14. A method of surface treating an aluminium or aluminium alloy part, comprising:
anodizing the part by immersing the part in an aqueous bath comprising sulfuric acid at a concentration of between 150 and 250 g/L and at a temperature of between 14 and 21° C., and
applying a direct voltage to the immersed part according to a voltage profile comprising a voltage rise at a rate of less than 1 V/min until reaching a voltage value referred to as plateau of between 5 and 13 V; and
clogging the anodic layer formed on the part, by clogging the part in an aqueous solution of deionized water having a resistivity equal to or greater than 0.01 MOhms, and from 1 to 500 g/L of an alkali metal or alkaline-earth metal silicate, at a temperature of between 60° C. and 100° C.

15. The method of surface treating an aluminium or aluminium alloy part, according to claim 1, comprising:
anodizing the part by immersing the part in an aqueous bath comprising sulfuric acid at a concentration of between 150 and 250 g/L and at a temperature of between 14 and 21° C., and
applying a direct voltage to the immersed part according to a voltage profile comprising a voltage rise at a rate of less than 1 V/min until a voltage value plateau of between 5 and 13 V is reached;
wherein immersing the part further comprises:
immersing the part in an aqueous bath containing a trivalent chromium salt selected from the group consisting of CrF₃,xH₂O, CrCl₃,xH₂O, Cr(NO₃)₃,xH₂O, (CH₃CO₂)₂Cr,xH₂O, (CH₃CO₂)₇Cr₃(OH)₂,xH₂O, Cr₂(SO₄)₃,xH₂O, CrK(SO₄)₂,xH₂O; and
immersing the part in an aqueous bath containing an oxidizing compound selected from the group consisting of hydrogen peroxide (H₂O₂), ammonium fluoride (NH₄F), potassium fluoro-zirconate (K₂ZrF₆), potassium permanganate (KMnO₄), sodium permanganate (NaMnO₄); and
clogging the part in an aqueous solution of deionized water having a resistivity equal to or greater than 0.01 MOhms, and from 1 to 500 g/L of an alkali metal or alkaline-earth metal silicate, at a temperature of between 60° C. and 100° C.

16. The method of surface treating an aluminium or aluminium alloy part, according to claim 1, comprising:
anodizing the part by immersing the part in an aqueous bath comprising sulfuric acid at a concentration of between 150 and 250 g/L and at a temperature of between 14 and 21° C., and
applying a direct voltage to the immersed part according to a voltage profile comprising a voltage rise at a rate of less than 1 V/min until a voltage value plateau between 5 and 13 V is reached;
immersing the part in an aqueous bath containing a trivalent chromium salt selected from the group consisting of CrF₃,xH₂O, CrCl₃,xH₂O, Cr(NO₃)₃,xH₂O, (CH3CO2)2Cr,xH2O, (CH3CO2)7Cr3(OH)2,xH2O, Cr2(SO4)3,xH2O, CrK(SO4)2,xH2O; and
immersing the part in an aqueous bath containing an oxidizing compound selected from the group consisting of hydrogen peroxide (H₂O₂), ammonium fluoride (NH₄F), potassium fluoro-zirconate (K₂ZrF₆), potassium permanganate (KMnO₄), sodium permanganate (NaMnO₄);
clogging the part in an aqueous solution of deionized water having a resistivity equal to or greater than 0.01 MOhms, and from 1 to 500 g/L of an alkali metal or alkaline-earth metal silicate, at a temperature between 60° C. and 100° C.; and
hydrothermally clogging the part in a deionized water with a resistivity equal to or greater than 0.01 MOhms, at a temperature between 97 and 100° C.

17. The method of surface treating an aluminium or aluminium alloy part, according to claim 1, comprising the following steps:
anodizing the part by immersing the part in an aqueous bath comprising sulfuric acid at a concentration of between 150 and 250 g/L and at a temperature of between 14 and 21° C., and
applying a direct voltage to the immersed part according to a voltage profile comprising a voltage rise at a rate of less than 1 V/min until a voltage value plateau between 5 and 13 V is reached;
immersing the part in an aqueous bath containing a trivalent chromium salt selected from the group consisting of CrF₃,xH₂O, CrCl₃,xH₂O, Cr(NO₃)₃,xH₂O, (CH₃CO₂)₂Cr,xH₂O, (CH₃CO₂)₇Cr₃(OH)₂,xH₂O, Cr₂(SO₄)₃,xH₂O, CrK(SO₄)₂,xH₂O; and
clogging the part in an aqueous solution of deionized water having a resistivity equal to or greater than 0.01 MOhms, and from 1 to 500 g/L of an alkali metal or alkaline-earth metal silicate, at a temperature of between 60° C. and 100° C.

18. The method for surface treating an aluminium or aluminium alloy part, according to claim 15, comprising, impregnating the anodized part in a bath of organic or mineral dyes before immersing the part in an aqueous bath containing a trivalent chromium salt.

19. A method for manufacturing an aluminium or aluminium alloy part intended for use in the aeronautical sector, the method comprising:
surface treating the part by a method according to claim 1, and optionally
applying one or more layers of paint, varnish, dry lubricants, or mastics.

20. (canceled)

21. An anodized aluminium or aluminium alloy part clogged by a surface treatment method according to claim 1, comprising one or more layers of paints, varnishes, dry lubricants or mastics, said part being intended for the aeronautical sector.
